(19) United States
(12) Patent Application Publication
(10) Pub. No.: US 2009/0158640 A1
(43) Pub. Date: Jun. 25, 2009

(54) PROCESS FOR PRODUCING BIODIESEL WITH IMPROVED FILTRATION CHARACTERISTICS AND BIODIESEL THUS PRODUCED

(75) Inventors: Marc Kellens, Mechelen-Muizen (BE); Francesco Soragna, Roma (IT); Wim De Greyt, Sinaai (BE)

Correspondence Address: CLARK & ELBING LLP, 101 FEDERAL STREET, BOSTON, MA, 02110, US

(73) Assignee: N.V. Desmet Ballestra Engineering S.A., Zaventem (BE)

(21) Appl. No.: 12/343,457

(22) Filed: Dec. 23, 2008

(30) Foreign Application Priority Data
Dec. 24, 2007 (GB) 0725194.5

(51) Int. Cl. C10L 1/18; C11C 3/06

(52) U.S. Cl. 44/308; 554/167

(57) ABSTRACT

A process for the production and purification of fatty acid esters of lower alkyl alcohols with improved filtration characteristics comprising the steps of: a) transesterifying a mixture of fatty acid esters of glycerol with a lower alkyl alcohol while using an alkaline catalyst; b) separating the reaction mixture resulting from step (a) into a glycerol phase and a fatty acid lower alkyl ester phase; c) inactivating the catalytic intermediates present in said fatty acid lower alkyl ester phase; d) removing the lower alkyl alcohol from the mixture resulting from step (c) by evaporation at reduced pressure to a value of less than 2% by weight; e) treating the evaporation residue resulting from step (d) with water; and f) isolating the fatty acid esters of lower alcohols by drying the product resulting from step (e); and biodiesel containing FAME produced according to this process.

### CROSS-REFERENCE TO RELATED APPLICATIONS

This application claims benefit from United Kingdom Application No. GB0725194.5, filed Dec. 24, 2007, which is incorporated herein by reference.

### FIELD OF THE INVENTION

The present invention relates to the production of lower alkyl esters of fatty acids to be used as fuel in compression ignition engines and having a reduced tendency to block fuel filters.

### BACKGROUND OF THE INVENTION

Fatty acid esters of lower alkyl alcohols, such as but not limited to fatty acid methyl esters (FAME), are produced by a transesterification reaction in which triglycerides, such as vegetable and animal oils and fats, are allowed to react with a lower alkyl alcohol such as methanol in the presence of an alkaline catalyst. This transesterification reaction is also referred to as an alcoholyis or methanolysis reaction as the case may be. When a stoichiometric excess of the lower alcohol is used, the transesterification is almost quantitative since the glycerol produced by the transesterification reaction does not dissolve in the fatty acid ester formed. The reaction is generally carried out at atmospheric pressure and at a temperature just below the boiling point of the lower alcohol but other reaction conditions involving elevated temperatures and high pressures have also been found effective in inducing the transesterification. An alkaline catalyst that is commonly used for the production of fatty acid methyl esters (FAME) is sodium methylate but other catalysts such as for example sodium ethylate, sodium hydroxide or potassium hydroxide can also be used.

During the production of FAME, triglyceride oil is mixed with a stoichiometric excess of methanol and a transesterification catalyst is added. This results in a two-phase system but as and when the transesterification proceeds and triglycerides are converted into partial glycerides and FAME, the solubility of the methanol in the fatty phase increases so that at a certain stage, the reaction mixture becomes homogeneous. As and when the transesterification proceeds further, the partial glyceride content of the fatty phase will decrease and glycerol will be formed. With the decrease of the partial glyceride content, the glycerol solubility in the fatty phase will decrease so that eventually, the glycerol will form a separate phase. Kinetically, this has the effect of promoting the conversion of glycerides to FAME since the phase separation decreases the concentration of the glycerol, a reaction partner in the transesterification equilibrium, and thus pulls this equilibrium to the FAME-side.

Said conversion may be further enhanced by separating the heavy glycerol phase from the light FAME phase and allowing the latter to react with an amount of fresh methanol containing some catalyst. This leads again to a heavy glycerol phase and a light FAME phase that can again be separated from each other by settling and decantation. Accordingly, the transesterification process outlined above leads to two phases: a FAME phase that also contains some methanol and some residual glycerol that is dissolved in the FAME but may also form a small separate phase as tiny droplets, and a glycerol phase that also contains some methanol, and a small amount of dissolved FAME.

Since methanol is far more soluble in glycerol than in FAME, the concentration of the methanol in the glycerol phase will be higher than the methanol concentration in the FAME phase, but since the glycerol phase constitutes only some 10% of the total reaction mixture, the major part of the methanol is nevertheless present in the FAME phase. In this respect, methanol differs from the catalytic activity as determined by acid/base titration. Apparently, the alkaline catalytic intermediate or intermediates have such a strong preference for the glycerol phase that this phase requires more acid for its neutralisation than the FAME phase. Any water present during the transesterification reaction may have caused the formation of soaps and they are also concentrated in the glycerol phase.

The reaction product of the transesterification must be purified. This purification is not only necessary to obtain reaction products that are within specification but also to recover non-reacted methanol and by-product fatty acids. A purification process that treats the reaction product as a whole, i.e. before phase separation, has been disclosed in EP 0 249 463 A1. According to said purification process, the reaction product is washed with an aqueous wash preparation comprising a surfactant such as for instance nonylphenol ethoxylate, a strong salt solution and a desaponificant such as for instance phosphoric acid.

However, most prior art purification processes start with a phase separation and then purify the phases separately. The glycerol phase can be acidulated to convert any soaps present into free fatty acids that can then be recovered quite easily since they from a separate phase. Methanol can be removed from the glycerol phase by evaporation, inorganic salts can be removed by filtration and the glycerol itself can be purified by distillation.

For the purification of the FAME phase, a number of different processes have been described in the literature. In a process to prepare carotenoid concentrates from palm oil by transesterifying the palm oil with methanol and separating the resulting FAME from the carotenoids by distillation, GB Patent No. 567,682 discloses a treatment comprising washing the FAME with a 50:50 mixture of alcohol and water, then washing the FAME with water alone and finally drying the FAME by vacuum nitrogen stripping before removing them by distillation.

The FAME phase can also be washed with water without prior washing with aqueous alcohol, as disclosed in U.S. Pat. No. 4,303,590. This water wash can then be followed by contacting the water-washed ester phase with at least one ion exchange resin as disclosed in EP 0 356 317 A1. However, these processes have the disadvantage that the methanol has to be recovered from the washing water. Accordingly, the treatment of the FAME phase disclosed in U.S. Pat. No. 2,383,633 commences by increasing the temperature to vaporise non-reacted methanol, but preferably only to a temperature insufficient for substantial reversal of the reaction in the absence of the alcohol. After the removal of the alcohol, the residue is acidified preferably with a mineral acid, and is thereafter allowed to settle.

The above processes are quite effective in inactivating the catalytic intermediate or intermediates involved in transesterification. In this context it should be noted that the chemical identity of this intermediate or these intermediates has not yet been unequivocally established. However, a possibility to be reckoned with entails that various anions such as the methanolate anion, the glycerolate anion and the enolate anion originating from the abstraction of an α-hydrogen from a fatty acid moiety, partake in various dynamic equilibria the positions of which are strongly affected by the concentrations of their reaction partners and the polarity of the phase. So although in some instances a single intermediate may play a predominant role, the species responsible for the catalytic activity will be referred to as ‘catalytic intermediates’ from hereon.

The above processes are also quite effective in removing methanol and glycerol and some minor constituents such as catalyst residues and free fatty acids and/or soaps from the FAME but triglyceride oil being a natural product, the FAME derived therefrom are likely to contain several minor constituents which may form part of the unsaponifiable. Some of these constituents such as tocopherols, act as natural antioxidants and their presence in the FAME is highly desirable since they increase the biodiesel stability but others can cause problems. In some instances, the biodiesel produced as described above throws a deposit or develops a haze and when such a product is used, it may cause fuel filters to become plugged. Consequently, biodiesel plants suffering from haze formation face the necessity to either prevent its formation or remove it once formed. Accordingly, current specifications for biodiesel limit the “Total Contamination” to a maximum value of 24 ppm; haze particles form part of this “Total Contamination”.

The chemical identity of haze particles has been investigated and this has led to a distinction between the so-called “soft haze” and “persistent haze”. The soft haze disappears when biodiesel is heated and comprises high melting FAME and/or high melting monoglycerides. Although a full analysis of persistent haze is still lacking, there is general agreement that persistent haze particles comprise sterol glucosides. These compounds have a very high melting point and therefore, persistent haze particles do not disappear on heating the biodiesel.

These sterol glucosides are assumed to stem from acylated sterol glucosides as illustrated below:

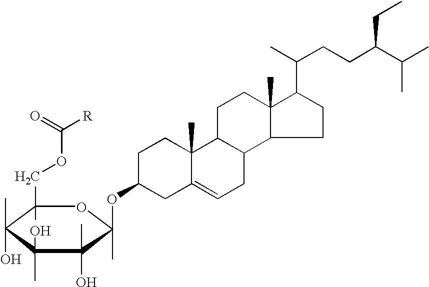

In this acylated sterol glucoside, the 6-position of the glucose moiety is esterified with a fatty acid such as but not limited to palmitic, stearic, oleic, linoleic or linolenic acid and the 1-position is linked to a sterol moiety such as but not limited to sitosterol or campesterol. It is further assumed that during the transesterification step with lower alkyl alcohols, this fatty acid is also transesterified under formation of fatty acid esters of said alcohols and free sterol glucosides. The latter will be less lipophilic than the acylated sterol glucosides and may therefore be less soluble in fatty acid methyl esters than their acylated precursors and accordingly, they may form a persistent haze. This haze forms part of the Total Contamination but other, as yet unknown compounds may also form part off the Total Contamination as demonstrated by the observations that samples biodiesel exhibiting a low sterol glucoside content may nevertheless show a high Total Contamination.

To improve the long term stability of biodiesel WO 2004/053036 A1 discloses a process wherein the crude ester formed by transesterification of a vegetable or animal oil or fat with methanol is intensively post-treated with a strong acid and a complexing agent such as ethylenediamine tetraacetic acid. The ester layer separated from the emulsion thus formed, is washed thoroughly with water and is subsequently dried. Another patent application (US 2007/0151146 A1) discloses various treatments of the biodiesel after it has been isolated from the FAME phase. Given the diversity of treatments disclosed in the prior art, it is evident that haze formation is a serious problem that has as yet not been satisfactorily solved.

### OBJECTS OF THE INVENTION

It is therefore an object of the invention to overcome the various disadvantages and shortcomings of the prior art processes for the improvement of the long-term stability and filtration characteristics of biodiesel.

### SUMMARY OF THE INVENTION

It has surprisingly been found that the above object can be attained by a process for the production and purification of fatty acid esters of lower alkyl alcohols, with improved filtration characteristics, comprising the steps of:
(a) transesterifying a mixture of fatty acid esters of glycerol with a lower alkyl alcohol while using an alkaline catalyst;
(b) separating the reaction mixture resulting from step (a) into a glycerol phase and a fatty acid lower alkyl ester phase;
(c) inactivating the catalytic intermediates present in said fatty acid lower alkyl ester;
(d) reducing the lower alkyl alcohol content in the mixture resulting from step (c) by evaporation at reduced pressure to a value of less than 2% by weight;
(e) treating the evaporation residue resulting from step (d) with water;
(f) isolating the fatty acid esters of lower alkyl alcohols by drying the product resulting from step (e).

It is an advantage of the process according to the invention that it effectively improves the filtration characteristics of the resulting biodiesel.

It is a further advantage of the process according to the invention that the inactivation of the catalytic intermediates in said fatty acid alkyl ester phase allows said lower alkyl alcohol to be removed without the transesterification equilibrium being shifted.

It is also an advantage of the process according to the invention that the lower alkyl alcohol that is recuperated is anhydrous and can therefore be recycled as such.

It is a further advantage of the process according to the invention that its incorporation into existing biodiesel plants hardly requires any major plant modification.

These and other advantages will become apparent from the description of the process according to the invention and its examples.

Accordingly, the invention features a process for the production and purification of fatty acid esters of lower alkyl alcohols with improved filtration characteristics comprising the steps of:

a) transesterifying a mixture of fatty acid esters of glycerol with a lower alkyl alcohol while using an alkaline catalyst;

b) separating the reaction mixture resulting from step (a) into a glycerol phase and a fatty acid lower alkyl ester phase;

c) inactivating the catalytic intermediates present in the fatty acid lower alkyl ester phase;

d) removing the lower alkyl alcohol from the mixture resulting from step (c) by evaporation at reduced pressure to a value of less than 2% by weight;

e) treating the evaporation residue resulting from step (d) with water; and

f) isolating the fatty acid esters of lower alcohols by drying the product resulting from step (e).

In any of the processes described herein, the lower alcohol may be methanol.

In any of the processes described herein, step (c) may be preceded by an additional step in which part of the lower alkyl alcohol present in the transesterification reaction product is removed by exposing this product to a slight vacuum. In some instances, the transesterification product may be the product resulting from step (a) or the product resulting from step (b).

In any of the processes described herein, the lower alkyl alcohol content after evaporation in step (d) may be 0.05% by weight or less.

In any of the processes described herein, step (d) may be omitted.

In any of the processes described herein, step (c) may be carried out in the absence of water.

In any of the processes described herein, the catalytic intermediates may be inactivated by exposing the fatty acid ester phase to a solution of an acid in a lower alkyl alcohol.

In any of the processes described herein, the catalytic intermediates may be inactivated by exposing the fatty acid ester phase to an acid activated ion exchange material.

In any of the processes described herein, the water used in step (e) may have been acidified.

In any of the processes described herein, the water used to treat the evaporation residue resulting from step (d) may be removed by centrifuge.

In any of the processes described herein, the dried fatty acid esters resulting from step (f) may be further purified by filtration.

The invention further features biodiesel containing FAME produced according to a process for the production and purification of fatty acid esters of lower alkyl alcohols with improved filtration characteristics comprising the steps of:

a) transesterifying a mixture of fatty acid esters of glycerol with a lower alkyl alcohol while using an alkaline catalyst;

b) separating the reaction mixture resulting from step (a) into a glycerol phase and a fatty acid lower alkyl ester phase;

c) inactivating the catalytic intermediates present in the fatty acid lower alkyl ester phase;

d) removing the lower alkyl alcohol from the mixture resulting from step (c) by evaporation at reduced pressure to a value of less than 2% by weight;

e) treating the evaporation residue resulting from step (d) with water; and

f) isolating the fatty acid esters of lower alcohols by drying the product resulting from step (e).

### DETAILED DESCRIPTION OF THE INVENTION

The first step (a) of the process according to the invention comprises a transesterification reaction wherein a fatty mixture of one or more fatty acid glycerol esters and a monohydric lower alkyl alcohol are allowed to react in the presence of a transesterification catalyst to produce a mixture comprising, as main components, fatty acid lower alkyl esters and glycerol. In the context of the present invention, this lower alcohol is defined as a C₁-C₄ alcohol selected from the group of methanol, ethanol, propanol, isopropanol and butanol that will henceforward be referred to as methanol. Similarly, fatty acid lower alkyl esters will henceforward be referred to as FAME.

The fatty mixture used in the process according to the invention can be of natural or synthetic origin; it can comprise triglycerides and partial glycerides. Its acid value is preferably below 1 mg KOH per gram which value can be easily attained by chemical or physical neutralisation processes that are known per se. Its water content is preferably below 100 ppm and more preferably below 50 ppm before the transesterification catalyst is added. These upper limits for free fatty acid content and water content are not mandatory and exceeding them does not exclude a successful transesterification; it only necessitates the use of more transesterification catalyst.

An alkaline transesterification catalyst such as but not limited to potassium hydroxide, sodium ethylate or sodium methylate (also referred to as sodium methoxide or sodium methanolate) is used in the process according to the invention. It can be added as such or as a solution in a lower alkyl alcohol. Sodium methylate for instance, is commercially available as a 30% solution in methanol. A stoichiometric excess with respect to the acidity of the starting material of 100 mol/tonne has been found to suffice for the transesterification to proceed.

As is well known to those skilled in the art, the transesterification can be carried out in stages that are separated from each other by removal of glycerol and the addition of a fresh solution of catalyst in methanol. If several stages are involved, the separation of the major part of the total amount of glycerol to be liberated by transesterification after the first stage constitutes step (b) of the process according to the invention. Glycerol removed from subsequent stages can be combined with the glycerol arising from step (b) but embodiments in which glycerol arising from subsequent stages is not separated from the FAME phase and in which the total reaction product is subjected to a catalyst inactivation treatment also fall within the scope of the present invention.

After the removal of the heavy, glycerol phase in step (b) of the process according to the present invention, a FAME phase results that contains most of the excess methanol, some residual and/or additional glycerol and most of the minor constituents that were present in the raw material. If these minor constituents contain ester linkages, such as the acyl sterol glucosides, these ester linkages may also have taken part in the transesterification and have resulted in free hydroxyl groups.

In specific embodiments of the process according to the invention, step (c) is preceded by an additional step in which part of the methanol present in the transesterification reaction product is removed by exposing this product to a slight vacuum. Said transesterification product can be either the product resulting from step (a) of the process according to the invention or the FAME phase resulting from step (b) of the process according to the invention. This additional step should not aim at complete removal of the lower alkyl alcohol since this is likely to cause the transesterification reaction to reverse and lead to the formation of partial glycerides. A residual lower alkyl alcohol content of 2% by weight has been found to be sufficiently high to avoid the reaction reversing noticeably. In yet another embodiment of the process according to the invention in which step (c) is preceded by said additional step, step (d) is omitted. Accordingly, the transesterification product from which part of the methanol has been removed by exposure to reduced pressure in said additional step is subjected in step (c) to a catalyst inactivation treatment whereupon the product is immediately washed with water.

In the process according to the invention, step (c), the inactivation of the catalytic intermediates, is performed on the FAME phase resulting from step (b) but it has been found that inactivation of the catalytic intermediates in the reaction mixture resulting from step (a) of the process according to the invention, i.e. before the phase separation of step (b), can also lead to sufficiently purified FAME. However, early inactivation of the catalytic intermediates has several disadvantages. Firstly, it requires more reagents because most of the catalytic intermediates are concentrated in the glycerol phase. Secondly, it increases the risk that the acid value of the resulting biodiesel exceeds its specification value of 0.5 mg KOH/g since more soaps will be dissolved in the glycerol phase than in the FAME phase. Thirdly, early inactivation of the catalytic intermediates prohibits the use of the glycerol phase as a neutralisation or pre-treatment agent of raw material to be transesterified.

In step (c) of the process according to the present invention, the catalytic intermediates present in the FAME phase are inactivated. This inactivation is preferably in the absence of water, since water might lead to the formation of free fatty acids that will dissolve in the FAME phase and contribute to the acid value of the resulting biodiesel. One way of inactivating the catalytic intermediates is by treating the fatty acid ester phase with a strong acid that is dissolved in or diluted with a lower alkyl alcohol such as methanol. Preferably, a strong solution is used to prevent the formation of a separate alcoholic phase and to minimise the amount of alcohol that has subsequently to be evaporated. In practice, solutions of 10% by weight or more have been found to be highly effective but the invention is in no way limited to this minimum strength. The type of acid has been found not to be critical provided it is sufficiently strong to inactivate the catalytic intermediates present in the FAME phase. Anhydrous citric acid has been found to be effective but other acids such as but not limited to phosphoric acid can be used as well in the process according to the invention. The amount of acid to be used must be in stoichiometric excess of the residual catalytic intermediates present in the FAME phase; the molar concentration of these intermediates in the FAME phase can be determined by measuring its alkalinity by titration. Using more constitutes an unnecessary expense and may convert soaps present in the FAME phase to free fatty acids.

The acid must be dispersed in the FAME phase and allowed to neutralise the residual alkalinity. However, by using a strong alcoholic solution of the acid and thereby avoiding the formation of a separate alcohol phase, no special mixers are required to disperse the acid uniformly through the fatty phase. In a batch reactor, the agitator used to mix the oil with the alcohol at the beginning of the process (step (a) of the process according to the invention) will be fully adequate to disperse the alcoholic solution of the acid. In a continuous system, a simple mixing device such as for instance a static mixer has been found to be satisfactory provided the alcoholic solution of the acid is metered sufficiently accurately into the product stream. In case of fluctuations, the amount of acid has to be increased so that its minima are still in excess of the stoichiometric requirements.

The temperature during the neutralisation process is not critical. Accordingly, the neutralisation is preferably carried out at the same temperature as the temperature of steps (a) and (b) of the process according to the invention. However, since step (d) may be carried out at a higher temperature which implies a heating stage, heating the reaction mixture before the addition of the neutralisation acid is also practicable and falls within the scope of the present invention.

Another way to inactivate the catalytic intermediates is by contacting the FAME phase with an acid activated ion exchange material. This can be a natural product such as a montmorillonite bleaching earth or a synthetic material like a resin carrying acid groups. In a batch process, the ion exchange material can be mixed with the FAME phase and then be removed by filtration. Both batch processes and continuous processes can also employ a column of ion exchange material that allows the FAME phase to be passed through.

In step (d) of the process according to the present invention, the methanol content is lowered to <2% by weight by evaporation under reduced pressure. Since the catalytic transesterification intermediates have been inactivated, there is no risk that removing the methanol will cause the transesterification equilibrium to shift and cause partial glycerides to be reconstituted. Since a low residual methanol content corresponds to a low Total Contamination, step (d) of the process according to the invention aims at a residual lower alcohol content <2% by weight and preferably <0.5% by weight. This can be achieved by exposing the FAME containing said lower alcohol to a reduced pressure. Heating the FAME phase and/or stripping said phase with an inert gas also assist in lowering its residual lower alcohol content.

In a batch process, a controlled evacuation of the batch reactor while its agitator is running will cause the alcohol to distil off in a gentle manner without the batch foaming into the condenser and causing it to block. The evaporation step (d) should be continued until the batch stops boiling after having reached a set temperature and pressure, the values of which depend on the type of lower alcohol and its residual content aimed for. In the case of methanol, a temperature of 80° C. and a pressure of 50 hPa can already bring the residual methanol content to below 0.01% by weight.

In a continuous process, the product stream may be passed through a heat exchanger to raise its temperature and then be sprayed into a flash vessel that is kept at sub-atmospheric pressure; because of the limited residence time in this vessel, its sump may also be sparged with an inert stripping medium to ensure a sufficiently low residual alcohol content.

In step (e) of the process according to the invention, the evaporation residue resulting from the previous step is treated with water. This treatment not only dissolves soaps and salts that originate from the transesterification catalyst, surprisingly it also transfers sterol glucosides if present from the FAME phase to the water phase. Accordingly, the water phase can have a milky appearance. The amount of water is not critical and in general an amount of 3% by weight has been found to be adequate. In most circumstances, there will be no need to acidify the washing water but occasionally, using slightly acidified washing water has been found to promote the transfer of sterol glucosides to the water phase.

The water added in step (e) of the process according to the invention can be removed by settling but in a preferred embodiment of the invention, the water is separated from the FAME by centrifuge. In another embodiment, the water is evaporated in step (f) of the process according to the invention and the resulting cloudy FAME is then purified by filtration.

Because the FAME phase will subsequently be dried in step (f) of the process according to the invention and since this drying step is facilitated by an elevated temperature, the water washing is preferably also carried out at this elevated temperature. Accordingly, the alcohol evaporation of step (d), the water washing of step (e) and the subsequent drying of step (f) are preferably carried out at substantially the same temperature, meaning that the temperature is not adjusted in between those three steps. However, embodiments comprising intermediate heating or cooling are to be considered as falling within the scope of the present invention.

### EXAMPLES

### Example 1

In this example, an embodiment of the process according to the invention comprising: transesterification, phase separation, catalyst inactivation in the fatty phase, methanol evaporation from said fatty phase and its washing with water, will be illustrated. Fully refined, bleached and deodorised (RBD) palm oil is used to prepare fatty acid methyl esters (FAME). Its free fatty acid content is 0.04% expressed as weight % oleic acid, its water content as determined by a Karl Fischer titration is 38 ppm, its residual phosphorus content is 5 ppm and its free sterol glucoside (SG) content is 4 ppm.

This SG content is determined by dissolving a sample in of heptane and applying its solution onto a Solid Phase Extraction column (SPE DSC-Si tubes, Discovery®, Sigma-Aldrich/Supelco, Bellefonte Pa., United States). The column is flushed with three heptane:ethyl acetate:isopropanol (70:25:5) aliquots and the sterol glucosides are then eluted with tetrahydrofurane:ethanol (50:50). The eluate is evaporated to dryness and dissolved in tetrahydrofurane for analysis by HPLC or GLC.

An amount of 700-800 g of this RBD palm oil is put in a multi-neck flask that is positioned in a water bath and heated to 60-62° C. When this temperature is reached, an amount of 21.7% by weight of pre-heated anhydrous methanol is added together with an amount of sodium methanolate solution in methanol that corresponds to 0.6% by weight of pure methanolate. The mixture is allowed to react for a period of 2 hours while being agitated (step (a) of the process according to the invention) and thereafter transferred to a separating funnel. The two phases: crude glycerol and crude FAME are separated from each other by decantation over a period of 1 hour.

An amount of 750 ppm anhydrous citric acid is added to the FAME phase as a 30% by weight solution in anhydrous methanol and the solution is mixed with the crude FAME. The amount of acid is apparently so small that it does not cause a separate phase to be formed and the crude FAME remains a clear liquid.

The acidulated FAME is then transferred to a Rotavapor® (Büchi Labortechnik A G, Flawil, Switzerland) and the methanol present therein is flashed off at a temperature of 80° C. and a pressure of 50 hPa absolute. Samples are taken at regular intervals and their residual methanol content is determined in accordance with EN 14110 via GLC headspace analysis while using an external standard.

The samples are washed with 3% by weight of water and then dried in Rotavapor® for 30 minutes at a temperature of 120° C. and an absolute pressure of 50 hPa. The analytical results of these samples have been listed in Table 1.

TABLE 1

| | | | | | |
|---|---|---|---|---|---|
| Methanol content after | weight % | 5.14 | 2.16 | 0.515 | 0.007 |
| flashing | | | | | |
| Water content after | ppm | 183 | 152 | 213 | 107 |
| drying | | | | | |
| Soap content after | ppm | 74.9 | 27.5 | 20.1 | 8.9 |
| drying | | | | | |
| Free SG after drying | ppm | 86 | 20 | 21 | 15 |
| Total contamination | ppm | 108.7 | 6.1 | 20. | 0.0 |
| after drying | | | | | |

Table 1 clearly shows that the amount of sterol glucosides (SG) in the final sample resulting after drying decreases when the residual methanol after the sample resulting after flash evaporation decreases. Apparently, ensuring almost complete methanol removal from the sample that has been treated with the citric acid causes the residual sterol glucoside content to be close to its solubility of some 15 ppm. Moreover, the total contamination as determined in accordance with EN 12662 decreases to such a low level no contamination can be detected in the sample having the lowest residual methanol content.

### Example 2

In this example, the desirability of the acid treatment preceding the evaporative removal of the methanol will be demonstrated. The palm oil described in Experiment 1 was used in the present example and the transesterification conditions were also the same. However, instead of inactivating the transesterification catalyst by the addition of citric acid, the fatty sample is immediately subjected to flash evaporation of the methanol; again samples were taken at regular intervals and analysed for residual methanol.

The samples were also washed with 3% by weight of water containing 2.5% by weight citric acid. Then they were dried at 120° C. at 50 hPa for a period of 30 minutes and the dry samples were analysed for residual water content, soap content, content of free sterol glucosides, Total Contamination and partial glycerides. Results are shown in Table 2.

TABLE 2

| | | | | | |
|---|---|---|---|---|---|
| Methanol content after | weight % | 5.48 | 3.17 | 0.358 | 0.013 |
| flashing | | | | | |
| Water content after | ppm | 126 | 38 | 169 | 174 |
| drying | | | | | |
| Soaps after drying | ppm | trace | 4.1 | trace | trace |
| Free SG after drying | ppm | 73 | 36 | 30 | 18 |
| Total Contamination | ppm | 60.2 | 14.3 | 22.1 | 17.9 |
| after drying | | | | | |

### Other Embodiments

All publications, patents, and patent applications mentioned in this specification are herein incorporated by reference to the same extent as if each independent publication or patent application was specifically and individually indicated to be incorporated by reference.

While the invention has been described in connection with specific embodiments thereof, it will be understood that it is capable of further modifications and this application is intended to cover any variations, uses, or adaptations of the invention following, in general, the principles of the invention and including such departures from the present disclosure that come within known or customary practice within the art to which the invention pertains and may be applied to the essential features hereinbefore set forth, and follows in the scope of the claims.

Other embodiments are within the claims.

What is claimed is:

1. A process for the production and purification of fatty acid esters of lower alkyl alcohols with improved filtration characteristics comprising the steps of:
a) transesterifying a mixture of fatty acid esters of glycerol with a lower alkyl alcohol while using an alkaline catalyst;
b) separating the reaction mixture resulting from step (a) into a glycerol phase and a fatty acid lower alkyl ester phase;
c) inactivating the catalytic intermediates present in said fatty acid lower alkyl ester phase;
d) removing the lower alkyl alcohol from the mixture resulting from step (c) by evaporation at reduced pressure to a value of less than 2% by weight;
e) treating the evaporation residue resulting from step (d) with water; and
f) isolating the fatty acid esters of lower alcohols by drying the product resulting from step (e).

2. The process according to claim 1 in which the lower alcohol is methanol.

3. The process according to claim 1 in which step (c) is preceded by an additional step in which part of the lower alkyl alcohol present in the transesterification reaction product is removed by exposing this product to a slight vacuum.

4. The process according to claim 3 in which said transesterification product is the product resulting from step (a).

5. The process according to claim 3 in which said transesterification product is the product resulting from step (b).

6. The process according to claim 1 in which the lower alkyl alcohol content after evaporation in step (d) is 0.05% by weight or less.

7. The process according to claim 3 in which step (d) is omitted.

8. The process according to claim 1 in which step (c) is carried out in the absence of water.

9. The process according to claim 1 in which the catalytic intermediates are inactivated by exposing the fatty acid ester phase to a solution of an acid in a lower alkyl alcohol.

10. The process according to claim 1 in which the catalytic intermediates are inactivated by exposing the fatty acid ester phase to an acid activated ion exchange material.

11. The process according to claim 1 in which the water used in step (e) has been acidified.

12. The process according to claim 1, in which the water used to treat the evaporation residue resulting from step (d) is removed by centrifuge.

13. The process according to claim 1 in which the dried fatty acid esters resulting from step (f) are further purified by filtration.

14. Biodiesel containing FAME produced according to a process for the production and purification of fatty acid esters of lower alkyl alcohols with improved filtration characteristics comprising the steps of:
a) transesterifying a mixture of fatty acid esters of glycerol with a lower alkyl alcohol while using an alkaline catalyst;
b) separating the reaction mixture resulting from step (a) into a glycerol phase and a fatty acid lower alkyl ester phase;
c) inactivating the catalytic intermediates present in said fatty acid lower alkyl ester phase;
d) removing the lower alkyl alcohol from the mixture resulting from step (c) by evaporation at reduced pressure to a value of less than 2% by weight;
e) treating the evaporation residue resulting from step (d) with water; and
f) isolating the fatty acid esters of lower alcohols by drying the product resulting from step (e).
